(19) United States
(12) Patent Application Publication
(10) Pub. No.: US 2007/0196614 A1
(43) Pub. Date: Aug. 23, 2007

(54) Heated Floor Element having a Surface Layer

(76) Inventor: Peter Kellner, Philippsthal (DE)

Correspondence Address: JORDAN AND HAMBURG LLP, 122 EAST 42ND STREET, SUITE 4000, NEW YORK, NY, 10168, US

(21) Appl. No.: 10/573,001

(22) PCT Filed: Oct. 10, 2003
(86) PCT No.: PCT/DE03/03357

§ 371 Date: Feb. 2, 2007

(30) Foreign Application Priority Data
Sep. 18, 2003 (DE) 203 14 548.8

(51) Int. Cl. B32B 3/16

(52) U.S. Cl. 428/49

(57) ABSTRACT

The invention relates to a floor element which is light-weight and easily transported, easily removed and therefore usable several times, is pleasant to walk on and can be used together with a floor heating system. The planar element for floors comprises a multilayer flag on the upper face of which a thin pressure-proof and abrasion-resistant flag, especially a natural stone flag, is disposed and on the lower face of which a pressure-proof light-density layer, fastened thereto by an adhesive glue, is disposed. Grooves are arranged in the vertical marginal areas of the light-density layer and connecting elements can be fixed in said grooves for connecting adjacent multilayer flags. According to the invention, the light-density layer consists of an expanded polypropylene foam.

### BACKGROUND OF THE INVENTION

The invention relates to a plane element for floors, comprising a multilayer plate having a thin pressure and abrasion resistant panel arranged at its top side, the panel in particular consisting of natural stone, and below this panel a pressure resistant lightweight material layer fixated by an adhesive connection, wherein grooves are arranged in vertical edge surfaces and connection ledges are arrangeable in said grooves for connecting adjacently layed multilayer plates.

The invention is designed, in particular, for removable and thus multiply reusable floors. With removable and multiply reusable floors that are needed, for example, for exhibitions it has been impossible to construct plane, high-quality floor areas having a high resilience hitherto, in particular using thin and thus lightweight natural stone panels. Permanently laying is also possible, of course. Additionally, floor heatings can be used efficiently in all cases.

In prior art removable floors for textile facings are known. The facing should be removable from the floor without residue and without damage to the facing.

In DE 36 00 807 C2 a method is given for this purpose, wherein a synthetics layer is arranged on both sides of a carrier material. At least one of them is glue-friendly, glue-impermeable and water-proof.

For applications with high stress load and outdoor applications it is known to lay stone elements, concrete elements or ceramic elements in mortar or on stilted bearings (German: Stelzlager). From DE 197 37 097 C2, a system for laying is known, in which laying panels (German: Verlegeplatten) are used that are layed separately besides each other or using a connecting disc body. The facing is firmly attached on the panels.

Usually, natural stone panels are thick and heavy in order to achieve the necessary stability. They are difficult to transport thus and therefore not suitable for multiple uses. Natural stone panels in thin and thus easy transportable designs have to be glued to a plane underlayer or layed in a mortar bed. Thus, they are not suitable for multiple uses, either.

In U.S. Pat. No. 4,855,177 as well as in DE 38 01 603 A1 and in WO 00 67 999 A1 compound bodies are described, where a panel of natural stone is furnished with a reinforcing layer.

However, these arrangements are not suitable in order to enable placing the single elements securely and exactly to a floor area.

Furthermore, from EP 0 252 434 A2 multilayer plates are known that have a thin pressure and abrasion resistant panel arranged at the top side, under which a pressure resistant lightweight material layer (4) is fixated by an adhesive connection.

Here, it is disadvantageous that there is a high risk of breaking for the edges of the pressure and abrasion resistant panel.

From DE 25 08 628 a floor element is known, comprising a wooden flake board below which a contiguous panel of foamed plastics is glued. The panel has parallel groove-shaped recesses at the upper and the lower support area.

The disadvantages of this floor element are, on the one hand, the parallel alignment of the groove-shaped recesses. Thus, the air transport in them is possible along two opposite directions only. On the other hand, the construction requires applying an additional covering onto the surface.

The WO 02/077389 A1 describes a floor of single plane elements in the form of multilayer plates having a respective pressure and abrasion resistant panel at their top side and a pressure resistant lightweight material layer fixated at its bottom side by an adhesive connection. Grooves can be arranged in vertical edge surfaces. Connection ledges are arrangeable in said grooves between several plates.

This floor has the disadvantage that polystyrene is used as lightweight material, which is, on the one hand, not elastically deformable. Thus, bumps in the ground deform the floor persistently. On the other hand, the stability of polystyrene is not very high. Another effect of the inelasticity is the hardness of the floor when walking on it. Additionally, a floor heating below the floor would be almost without effect because of the good isolation.

It is an object of the invention to specify a floor design having high stability using single elements which are lightweight and easy transportable as well as simply removable and thus multiply usable, the elements additionally being comfortable to walk on and enabling an application above floor heatings.

### SUMMARY OF THE INVENTION

The invention has a number of advantages.

Because of the multilayer construction of the single plates comprising a respective thin panel at the top side and a pressure resistant lightweight material layer arranged and glued below, the lightweight material layer consisting of expanded polypropylene foam, lightweight floor elements can be realized having a high-quality surface and sufficient stability.

By arranging grooves in the borders of the lightweight material layer and by placing connection ledges in the grooves between respective adjacently layed multilayer plates, the floor elements can be secured against displacements along ajoint direction as well as steps between adjacently layed multilayer plates can be avoided.

By furrows in the top side, that are preferably crossed, the elements are suitable for dissipating and conducting condensation and air moisture and for supplying warm air from a floor heating. By furrows in the bottom side, that are preferably crossed, it is possible to dissipate moisture.

If the grooves are shorter than the elements are wide the comers of the panel and of the light weight material layer are in superficially extended contact and flush with each other. Thereby, on the one hand, load transmission at the borders is improved and, on the other hand, the risk of damages by external forces as, for example, when jamming with tools is decreased. This is especially of interest when oftentimes setting up and taking down.

Openings in the lightweight material layer enable to supply warm air from heat sources situated below the floor. Furrows in the top of the lightweight material layer, touching or crossing these openings, provide an extensive distribution of the warm air.

By gluing a thin, two-dimensionally extended reinforcement having a high stability and a high Young's modulus between the upper panel and the lightweight material layer, it is possible to realize a very high stability of the floor elements even when using very thin panels and thus very lightweight floor elements. This stability causes a sufficient break resistance even in case of high punctual stresses occurring, for example, when setting up punctually supported shelves or cupboards, without a necessity for laying the floor elements in a mortar bed or for gluing the floor elements to an underlayer.

### BRIEF DESCRIPTION OF THE DRAWINGS

The invention is briefly described using an exemplary embodiment. The accompanying drawings show in:

FIG. 1 a cross section through a plate according to the invention,

FIG. 2 a bottom view of a multilayer plate according to the invention,

FIG. 3 a connection ledge according to the invention,

FIG. 4 a cut-out from a whole arrangement of a floor and

FIG. 5 a detail of a joint.

### DETAILED DESCRIPTION OF THE INVENTION

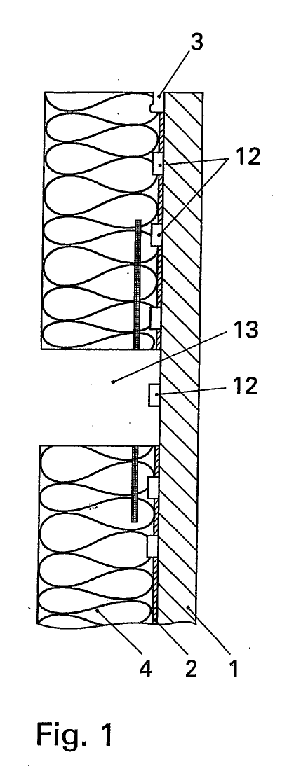

The cross section through a multilayer plate in accordance with the invention depicted in FIG. 1 shows a thin panel 1 of natural stone, at whose bottom a CFRP fabric of small thickness is two-dimensionally glued as a two-dimensionally extended reinforcement 2 by means of an epoxy resin. The thin panel 1 can also consist of glass, wood, metal or another stable material. The CFRP fabric exhibits a high Young's modulus in relation to the natural stone panel; the tensile strength and the compression strength of the CFRP fabric is essentially larger than the compression strength of the natural stone. Below the CFRP fabric a pressure resistant foam layer of expanded polypropylene is two-dimensionally glued. By the shown multilayer construction a high tensile bending strength is achieved at a low weight of the multilayer plate. An advisable embodiment provides for that the reinforcement 2 is arranged within the lightweight material layer 4. Reinforcement elements can be advantageously inserted by working slits or grooves into the lightweight material layer 4 for receiving strip-shaped reinforcements 2. For example, the grooves can be worked into preassembled lightweight material panels already before connecting with the thin panel 1, in order to glue strip-shaped reinforcements 2 into these grooves later. Slits can be achieved, for example, by gluing the lightweight material panels in smaller parts to the panel 1, leaving appropriate gaps between them.

At all four edges of the lightweight material layer 4 of the quadratic floor plate, grooves 3 are arranged, serving for receiving connection ledges 9. The plates can have edge lengths from 200 mm to 2200 mm. Preferably squares with an edge length of 300 mm to 500 mm and a thickness of 10 mm to 40 mm are used. The grooves 3 are preferably shorter than the edges of the plates, so that the lightweight material layer 4 flushes with the panel 1 at the corners. The grooves can be placed either directly at the boundary surface between panel 1 and lightweight material layer 4 or within the lightweight material layer 4 in a distance from the boundary surface.

At the top side and the bottom side of the lightweight material layer 4 there are arranged furrows 12 crossing each other. In the furrows 12, condensation moisture that has arised at the bottom of the panel 1 can evaporate and be dissipated. Also, air moisture coming from the ground or water entering from the panel 1 can be guided through the furrows 12 to the border of the floor area.

The furrows can be arranged in parallel and congruently above each other on the top side and the bottom side or they can be offset in relation to each other.

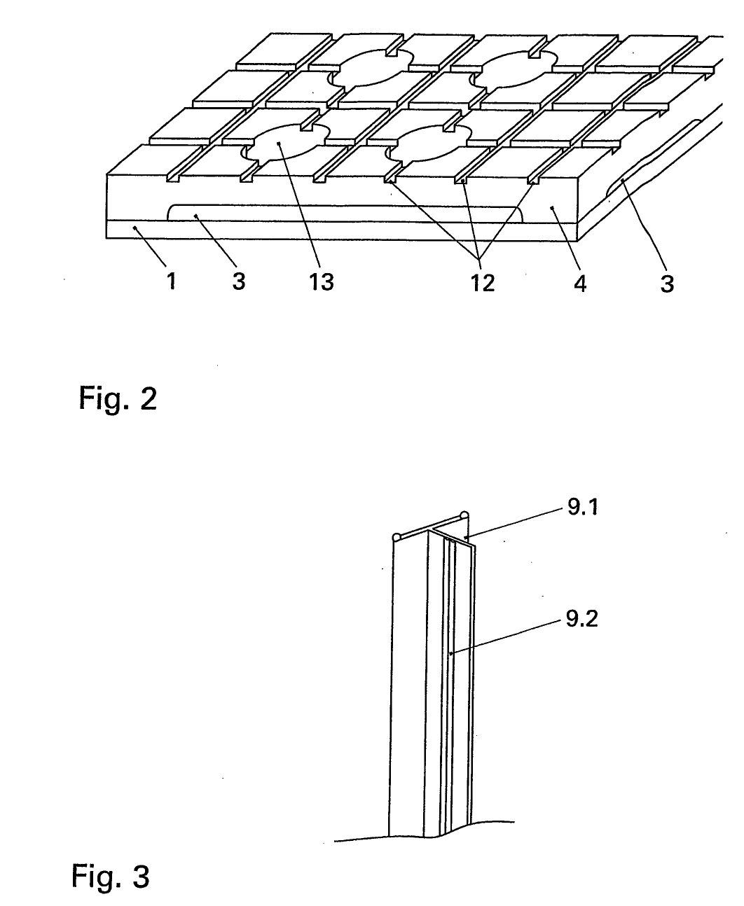

Using the openings 13 depicted in FIG. 2, which is an isometric bottom view of the element according to the invention, the openings preferably touching the furrows 12, in particular at cross-over points of the furrows, warm air can be guided from a heat source located below the lightweight material layer to the panel 1. Through the furrows 12 the warm air is supplied to a larger surface and the panel 1 is heated this way.

In this embodiment it is advantageous to use a foam material of an increased density so that the decreased payload resulting from the openings can be counterbalanced.

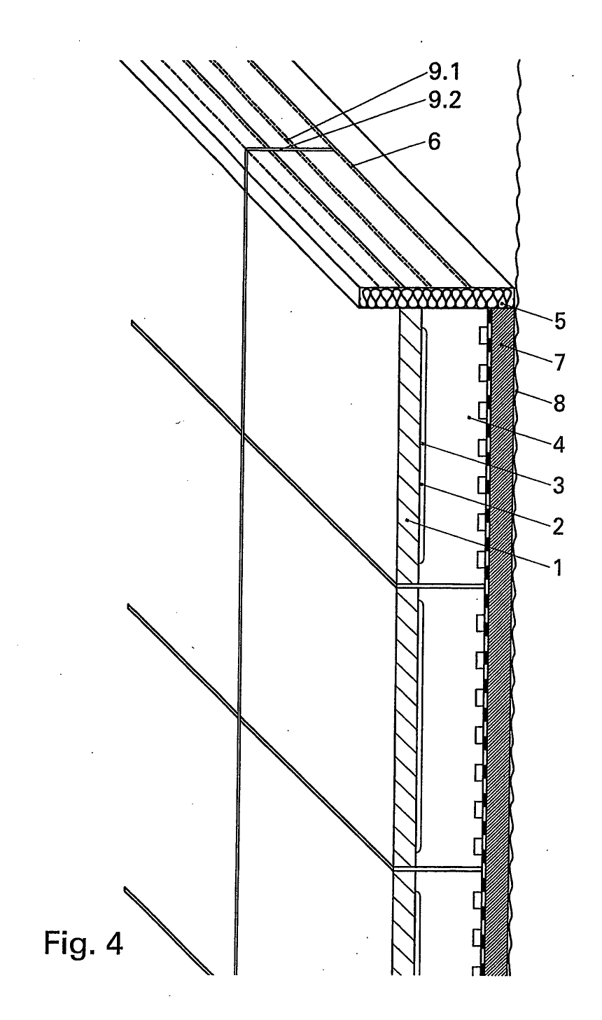

A connection ledge 9 is shown in FIG. 3. The connection ledge 9 comprises at least two horizontal blades 9.1. The embodiment depicted in FIG. 3 is similar to a T-shaped profile and comprises two horizontal blades 9.1 and an additional vertical blade 9.2. The thickness of the horizontal blade 9.1 is slightly smaller than the width of the grooves 3. Alongside the profile flutings are arranged at the horizontal blades 9.1, serving for securely clamping the horizontal blades 9.1 in the grooves 3 and thus serving for connecting adjacently arranged multilayer plates. In order to ease assembly it is advisable to provide the ends of the horizontal blades 9.1 with a conic chamfer at least at the bottom. The vertical blade 9.2 serves for preserving a defined butt joint width between the multilayer plates.

FIG. 4 shows an isometric cut-out of a whole floor arrangement comprising several multilayer plates connected by respective connection ledges 9. The multilayer plates are layed on a plane underlayer. The underlayer comprises a lower film 8 and a fast-setting floating floor screed 7 applied thereonto. Above the floating floor screed 7 an upper film 6 is arranged. In order to laterally terminate the floor there is an L-shaped metal angle profile 5 arranged whose horizontal blade is covered by the floating floor screed 7. The angle profile 5 is affixed in the underlayer by this cover. At the side that is directed to the floor the vertical blade of the angle profile 5 is provided with a compressible gasket strip preventing a leakage of mortar from the frame.

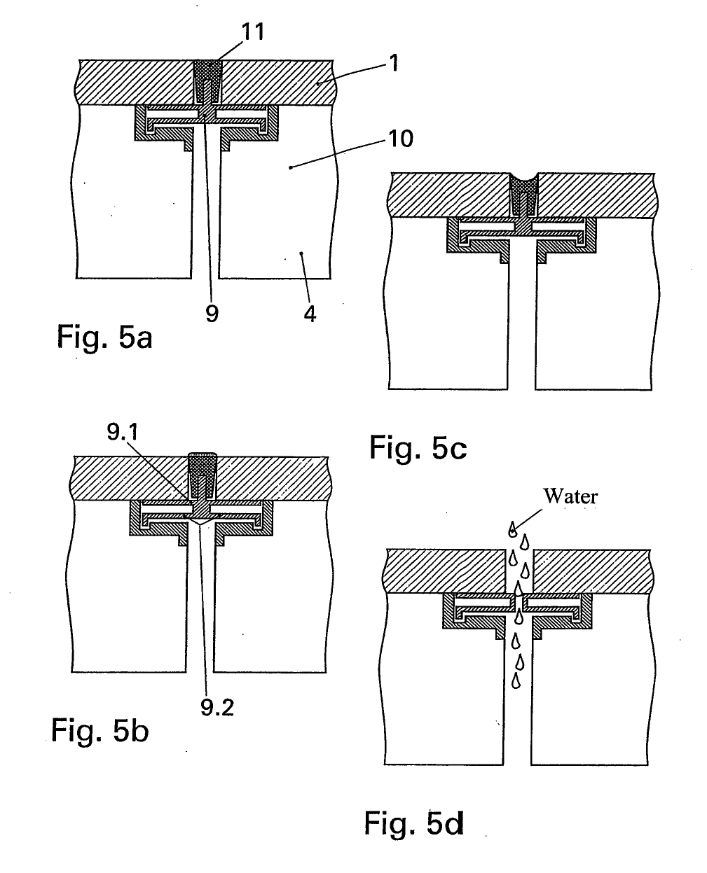

FIG. 5 illustrates a detail of a joint where additional fixation bars 10 are located in the side faces of the lightweight material layer 4. The fixation bars 10 have a groove into which the horizontal blades 9.1 of the connection ledges 9 engage. Advantageously, the horizontal blades 9.1 are designed to be elastic by the use of a slit and are provided with sections of reinforced thickness which snap into corresponding undercuts arranged at the inner surfaces of the fixation bars. The sections ofreinforced thickness enable a form-locking, but detachable connection and thus a secure and gap-free arrangement of adjacent plates.

It is also possible that the vertical blades 9.2 are provided at their top with a colored lipping 11 consisting of an elastic synthetic material, the lipping 11 both performing decorative tasks and improving the sealing. The surface of the lipping 11 can be plane as shown in FIG. 5a, embossed as shown in FIG. 5b or can be formed as a channel as shown in FIG. 5c. Moreover, it is possible to use types of the connection ledge 9 without a vertical blade 9.1. This embodiment is in particular suitable for an outdoor application with terrace plates and is depicted in FIG. 5d. Here, the connection ledge 9 consists only of the two horizontal blades 9.2 provided with openings. Thereby it is possible to dissipate water from the top of the plates which can drain into the gap between adjacent plates and through the connection ledges 9.

Preferably, the grooves 3 are created by taking them out of the lightweight material layer 4, so that the additional complex use of fixation bars 10 can be omitted.

In the case of grooves in a distance from the boundary layer, it is useful to put undercuts to the top ofthe grooves 3, too, and also to provide the connection ledges 9 with sections of reinforced thickness at the horizontal blades.

Other layers can be arranged between the lightweight material layer 4 and the panel 1, for example, a metal layer in order to more uniformly distribute the heat of a heating.

The furrows 12 can be either designed to be contiguous so that long tubes form in an assembly of several floor elements, or they can end within the lightweight material layer 4 so that they do not penetrate its border and the border of the grooves 3, respectively.

### LIST OF REFERENCE NUMERALS

1. Panel
2. Reinforcement
3. Groove
4. Lightweight material layer
5. Angle profile
6. Upper film
7. Floating floor screed
8. Lower film
9. Connection Ledge
9.1 Horizontal blade
9.2 Vertical blade
10. Fixation bar
11. Lipping
12. Furrow
13. Opening

1.-25. (canceled)

26. A plane element for floors comprising
a multilayer plate having a top face and a bottom face, the multilayer plate comprising
a thin pressure and abrasion resistant panel having a top face to be exposed as the top face of the plane element upon installation of the plane element and a bottom face, and
a layer of pressure resistant lightweight material having a top face adhered to the panel bottom face and a bottom face, the layer of pressure resistant lightweight material comprising polypropylene,
and wherein grooves are situated in vertical edges of the plate beneath the panel, the grooves having a depthwise dimension vertical to said faces, each of the grooves being adapted to receive a connecting element comprising ledges adapted to be received in the grooves of adjacent said plane elements for connecting said adjacent plane elements together when said plane elements are side-by-side on a flat surface.

27. The plane element according to claim 26, wherein
the respective grooves are of lesser length than the respective edges at which the grooves are formed and do not extend to comers of the plate, whereby the panel and the lightweight material layer are substantially flush apart from any irregularities in the edges.

28. The plane element according to claim 26, wherein
furrows are formed in the bottom face of the lightweight material layer.

29. The plane element according to claim 26, wherein
furrows are formed in the top face of the lightweight material layer.

30. The plane element according to claim 26, wherein
furrows are formed in both faces of the lightweight material.

31. The plane element according to claim 28, 29 or 30, wherein
the furrows extend in two orthogonal directions.

32. The plane element according to claim 26 or 27, wherein
furrows are formed in at least one of the faces of the lightweight material layer and have a depth of 1 mm to 10 mm.

33. The plane element according to claim 26 or 27, wherein
vertical openings are formed through the lightweight material layer.

34. The plane element according to claim 31, wherein
vertical openings are formed through the lightweight materials,
and at least one of said openings is located at where two of said grooves extending in orthogonal directions would otherwise intersect.

35. The plane element according to claim 26, further comprising
a planar reinforcing material situated between and coextensive with and adhered to at least respective portions of the bottom face of the panel and the top face of the lightweight material, the planar reinforcing material being highly stable and being of lesser thicknesses and higher Young's modulus than the panel.

36. The plane element according to claim 35, wherein
the planar reinforcing material is comprised of at least one of CFRP, CFRP fabric, glass fibers or metal.

37. The planar element according to claim 35 or 36, wherein
the reinforcing material is received in the lightweight material layer.

38. The planar element according to claim 37, wherein
slits or grooves spaced from said edges of the lightweight material layer for receiving the lightweight material layer are formed in the lightweight material layer, the reinforcing material is in the form of strips and the strips are received in the reinforcing material-receiving slits or grooves.

39. The plane element according to claim 26 or 27,
wherein the plane element is quadrilateral, is of thickness 10 to 20 mm and has edges of length 300 to 500 mm.

40. A flooring kit, comprising
a plurality of plane elements according to claim 26 or 27, and
a plurality of connecting elements comprising ledges adapted to be received in the grooves of adjacent said plane elements for connecting said adjacent plane elements together when said plane elements are side-by side on a flat surface.

41. The flooring kit according to claim 40, wherein
each said connecting element comprises a vertical blade of a height predetermined so that a top edge of the vertical blade will be substantially flush with the top face of the panel upon installation of the flooring and two horizontal blades on opposite sides of the vertical blade, the two vertical blades comprising said ledges and being of width slightly smaller than width of the grooves.

42. The flooring kit according to claim 41, further comprising
liner elements for the grooves, the liner elements being comprised of a material different from the lightweight material and being received in the grooves.

43. The flooring kit according to claim 41, wherein
the top edge is covered by a decorative material.

44. The flooring kit according to claim 41, wherein
portions of the horizontal blades are of greater thickness than the remainder of the horizontal blades for firmer engagement in the grooves.

45. The flooring kit according to claim 41,
wherein the ledges are so configured as to form a miter at upper edges thereof when the respective ledges meet at the cross-over of plates joined in two horizontal directions.

46. The plane element according to claim 28, 29 or 30, wherein
the furrows are spaced from the grooves and/or edges of the lightweight material layer.

47. The plane element according to claim 28, 29 or 30, wherein
the furrows impinge on the grooves and/or edges of the lightweight material layer.

48. The plane element according to claim 26 or 27, further comprising
additional layers between the panel and the lightweight material layer.

49. The plane element according to claims 26 or 27, further comprising
at least one additional layer adjacent the bottom face of the lightweight material layer.

50. The plane element according to claim 49, further comprising
fleece on the bottom face of the lightweight material layer as glue primer, and
an application of glue on the primer,
wherein the at least one additional layer is adhered by means of the glue-bearing primer to the bottom face of the lightweight layer material.

51. The plane element according to claim 26 or 27, wherein
the plate is comprised of atleast one of natural stone, glass, wood or metal.

52. The plane element according to claim 26 or 27, wherein the plane is comprised of natural stone.
